(19) United States
(12) Patent Application Publication
(10) Pub. No.: US 2015/0085995 A1
(43) Pub. Date: Mar. 26, 2015

(54) SELT AND DELT BASED DIAGNOSTIC METHODS & SYSTEMS FOR TWISTED PAIR TELEPHONE LINES

(71) Applicants: Mehdi Mohseni, Menlo Park, CA (US); Ehsan Ardestani, Foster City, CA (US)

(72) Inventors: Mehdi Mohseni, Menlo Park, CA (US); Ehsan Ardestani, Foster City, CA (US)

(73) Assignee: Adaptive Spectrum and Signal Alignment, Inc., Redwood City, CA (US)

(21) Appl. No.: 14/394,076

(22) PCT Filed: Apr. 12, 2012
(86) PCT No.: PCT/US2012/033379

§ 371 Date: Oct. 10, 2014

(51) Int. Cl. H04M 3/22

(52) U.S. Cl. CPC H04M 3/2209
USPC 379/22

(57) ABSTRACT

Methods and systems to improve accuracy and fault detection capability of automated line diagnostics through at least one of: joint processing of SELT and DELT data; comparisons of relative strengths of peaks and/or dips to envelope and/or peaks to dips in a time domain echo response; and iterative diagnostics whereby an echo response is adjusted through signal processing techniques, for example to remove lengths of straight line, between successive performance of a detection algorithm. More than one of the diagnostic systems and methods described herein may be employed in combination to improve accuracy and fault detection capability. For example, where SELT and DELT data are jointly processed, analysis of the SELT data may employ the ratio tests described in the context of a SELT diagnostic routine. Similarly, the SELT diagnostics method assessing relative strengths of peaks and dip in an echo response via ratio tests may be combined with iterative adjustment of the echo response.

### TECHNICAL FIELD

The subject matter described herein relates generally to the field of telecommunication, and more particularly to systems and methods for automated determinations of a physical configuration and diagnostics of twisted pair telephone lines in a digital subscriber line (DSL) network.

### BACKGROUND

Digital subscriber line (DSL) technologies generally include digital subscriber line equipment and services using packet-based architectures, such as, for example, Asymmetric DSL (ADSL), High-speed DSL (HDSL), Symmetric DSL (SDSL), and/or Very high-speed/Very high-bit-rate DSL (VDSL). Such DSL technologies can provide extremely high bandwidth over a twisted pair line and offers great potential for bandwidth-intensive applications. DSL services in the 30K-30 MHz band are however more dependent on line conditions (for example, the length, quality and environment of the line) than is Plain Old Telephone Service (POTS) operating in the <4K band.

While some lines (loops) are in good physical condition for implementing DSL (for example, having short to moderate lengths with operative micro-filters or splitters correctly installed and with no bridged taps and no bad splices), many lines are not as suitable. For example, line length varies widely, the wire gauge for a line may not be consistent over the length of the line (having two or more different gauges spliced together), micro-filters may be missing or inoperative, and many existing lines have one or more bridged taps (a length of wire pair that is tapped off a line at one end or anywhere along the length of line and is unconnected or poorly terminated).

Assessment of a line's physical configuration (referred to herein as “line diagnostics”) is an important step in the implementation of any DSL network. Physical line parameters characterized by line diagnostics includes: detection of any of the various faults listed above; localization of detected faults; and characterization of the fault with respect to one or more descriptors (e.g., a length of a bridged-tap). Such physical line diagnostics are important because the bit-rate that can be achieved for a given type of DSL technology is dependent on the physical configuration of the line. Spectrum management activities performed over a population of given lines, for example to minimize crosstalk problems, are also dependent on the physical configuration of a line.

Line diagnostics in the art generally include single-ended line testing (SELT) techniques estimating a line transfer function using equipment disposed one end of the line with any termination at the other end but without data collection at the second end, and double-ended line testing (DELT) techniques that directly measure a line transfer function with equipment disposed at both ends of the line. SELT techniques generally employ reflectometry, relying on the fact that as a signal propagates through a medium, part of it is reflected by discontinuities in that medium. Reflectometric techniques include frequency domain reflectometry (FDR) where a waveform of swept frequency (multi-tone) is sent down the line, and time domain reflectometry (TDR) where a pulsed waveform is sent down the line. In either form, an echo response is collected and analyzed with respect to one or more of at least frequency, amplitude, and polarity to estimate the line configuration (e.g., detect one or more of the line faults above).

While line diagnostics based on either SELT or DELT has been extensively studied, automated line diagnostic algorithms remain a subject of intense study. Accurate estimation of line configuration depends on avoiding misdetection resulting from either a first type of error where algorithm sensitivity to real features is too low, or a second type of error where sensitivity to spurious features is too high. Many TDR-based diagnostic algorithms rely on identifying from a bank of possible templates a line configuration template having the highest correlation with the echo response of the line under test. Accuracy of a TDR-based diagnostic algorithm relying on a template bank is therefore a function of the size of the bank. As larger banks increase processing complexity and processing time, diagnostic results are practically limited.

Techniques improving detection capability as well as accuracy of automated line diagnostics are therefore very useful.

### BRIEF DESCRIPTION OF THE DRAWINGS

Embodiments of the present invention are illustrated by way of example, and not by way of limitation, and can be more fully understood with reference to the following detailed description when considered in connection with the figures in which:

FIG. 1 illustrates an exemplary network architecture in which embodiments of the present invention may operate;

FIG. 2A is a flow diagram illustrating a line diagnostics method including joint processing of SELT and DELT data, in accordance with an embodiment of the present invention;

FIG. 2B is a flow diagram illustrating a method of joint processing SELT and DELT data to determine a physical configuration of a line, in accordance with an embodiment;

FIG. 3 is a functional block diagram illustrating a system configured to perform joint processing of SELT and DELT data collected from the exemplary network illustrated in FIG. 1, in accordance with an embodiment;

FIG. 4A is a flow diagram illustrating an iterative SELT diagnostic method employing ratio tests, in accordance with an embodiment;

FIG. 4B is a flow diagram illustrating exemplary peak/dip ratio tests performed on a time domain echo response, performed as a portion of the iterative SELT diagnostic method illustrated in FIG. 4A, in accordance with an embodiment;

FIG. 4C is a flow diagram further illustrating exemplary peak/dip ratio tests performed on a time domain echo response, performed as a portion of the iterative SELT diagnostic method illustrated in FIG. 4A, in accordance with an embodiment;

FIG. 4D is a flow diagram illustrating a method for adjusting the echo response based on the estimation of the physical configuration that is performed as a portion of the iterative SELT diagnostic method illustrated in FIG. 4A, in accordance with an embodiment;

FIG. 5A is an exemplary time domain echo response that may be operated on following the iterative SELT diagnostic method illustrated n FIG. 4A;

FIG. 5B is an exemplary time domain echo response that has been adjusted following the method illustrated in FIG. 4D, in accordance with an embodiment;

FIG. 6 is a functional block diagram illustrating a system configured to perform the iterative SELT diagnostic method illustrated in FIG. 4A on SELT data collected from the exemplary network illustrated in FIG. 1, in accordance with an embodiment; and

FIG. 7 is a diagrammatic representation of a machine in the exemplary form of a computer system that is configured to automatically perform at least one, and preferably all, of the functional blocks illustrated in FIG. 3 and FIG. 6, in accordance with embodiments of the present invention.

### DETAILED DESCRIPTION

Described herein are methods and systems for twisted pair telephone line diagnostics. For brevity, the exemplary embodiments are described in the context of a DSL network. As used herein, “line diagnostics” refers to detection or determination of a physical line configuration parameter, such as, but not limited to, detection of a series fault, shunt fault, and bridged tap, localization of a fault, a characterization of the fault (e.g., bridged tap length). The diagnostic methods described herein, though illustrated for particular line configuration parameters, may be readily apply by those of ordinary skill in the art toward diagnosis of any other physical line configuration parameters which are known in the art to generate similar physical phenomena on a line. For example, it is envisioned that at least microfilter problems can also be detected and/or characterized by the diagnostics techniques described herein. Further extension of the methods and systems described herein may be made to improve detection of changes in wire gauge, for example.

Embodiments of the present invention improve accuracy and fault detection capability through at least one of: joint processing of SELT and DELT data; tests analyzing relative strengths of peaks and/or dips to envelope and peaks to dips in a time domain echo response; and iterative diagnostics whereby an echo response is adjusted through signal processing techniques between successive performance of a detection algorithm. In embodiments, more than one of the diagnostic systems and methods described herein are employed in combination to improve accuracy and fault detection capability. For example, in one embodiment where SELT and DELT data are jointly processed, analysis of the SELT data may employ the ratio tests described in the context of SELT diagnostics. Similarly, the SELT diagnostics employing ratio tests described herein are, in an embodiment, combined with iterative adjustment of the echo response. In further embodiments, iterative SELT diagnostics employing ratio tests are employed as the SELT analysis portion in joint processing of SELT and DELT data.

In the following description, numerous specific details are set forth such as examples of specific systems, languages, components, etc., in order to provide a thorough understanding of the various embodiments. It will be apparent, however, to one skilled in the art that these specific details need not be employed to practice the disclosed embodiments. In other instances, well known materials or methods have not been described in detail in order to avoid unnecessarily obscuring the disclosed embodiments.

In addition to various hardware components depicted in the figures and described herein, embodiments further include various operations which are described below. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software, including software instructions that perform the operations described herein via memory and one or more processors of a computing platform.

Embodiments also relate to a system or apparatus for performing the operations herein. The disclosed system or apparatus may be specially constructed for the required purposes, or it may comprise a general purpose computer selectively activated or reconfigured by a computer program stored in the computer or accessed through cloud storage. Such a computer program may be stored in a computer readable storage medium, such as, but not limited to, any type of disk including floppy disks, optical disks, flash, NAND, solid state drives (SSDs), CD-ROMs, magnetic-optical disks, read-only memories (ROMs), random access memories (RAMs), EPROMs, EEPROMs, magnetic or optical cards, or any similar type of non-transitory media suitable for storing electronic instructions on a time scale that is sufficient to be considered non-transitory by one of ordinary skill in the art. In one embodiment, a non-transitory computer readable storage medium having instructions stored thereon, causes one or more processors within a Diagnostics Device to perform the diagnostic methods and operations described herein. In another embodiment, the instructions to perform such methods and operations are stored upon a non-transitory computer readable medium for later execution.

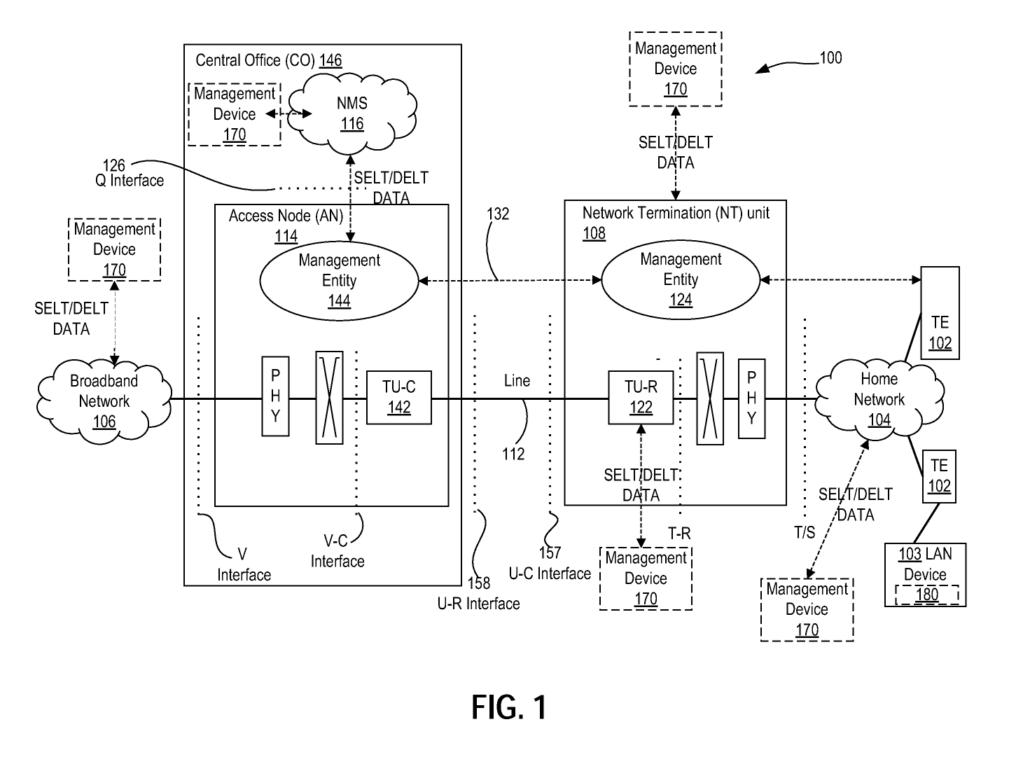

FIG. 1 illustrates an exemplary network architecture 100 in which embodiments may operate in compliance with the G.997.1 standard (also known as G.ploam). Asymmetric Digital Subscriber Line (ADSL) systems (one form of Digital Subscriber Line (DSL) systems), which may or may not include splitters, operate in compliance with the various applicable standards such as ADSL1 (G.992.1), ADSL-Lite (G.992.2), ADSL2 (G.992.3), ADSL2-Lite G.992.4, ADSL2+(G.992.5) and the G.993.x emerging Very-high-speed Digital Subscriber Line or Very-high-bitrate Digital Subscriber Line (VDSL) standards, as well as the G.991.1 and G.991.2 Single-Pair High-speed Digital Subscriber Line (SHDSL) standards, all with and without bonding.

The G.997.1 standard specifies the physical layer management for ADSL transmission systems based on the clear, Embedded Operation Channel (EOC) defined in G.997.1 and use of indicator bits and EOC messages defined in G.992.x standards. Moreover, G.997.1 specifies network management elements content for configuration, fault and performance management. In performing the disclosed functions, systems may utilize a variety of operational data (which includes performance data) that is available at an Access Node (AN).

In FIG. 1, a user's terminal equipment 102 (e.g., a Customer Premises Equipment (CPE) device or a remote terminal device, network node, LAN device, etc.) is coupled to a home network 104, which in turn is coupled to a Network termination (NT) Unit 108. DSL Transceiver Units (TU) are further depicted (e.g., a device that provides modulation on a DSL loop or line). In one embodiment, NT unit 108 includes a TU-R (TU Remote), 122 (for example, a transceiver defined by one of the ADSL or VDSL standards) or any other suitable network termination modem, transceiver or other communication unit. NT unit 108 also includes a Management Entity (ME) 124. Management Entity 124 may be any suitable hardware device, such as a microprocessor, microcontroller, or circuit state machine in firmware or hardware, capable of performing as required by any applicable standards and/or other criteria. Management Entity 124 collects and stores, among other things, operational data, performance data (e.g., SELT and/or DELT data) in its Management Information Base (MIB), which is a database of information maintained by each ME capable of being accessed via network management protocols such as Simple Network Management Protocol (SNMP), an administration protocol used to gather information from a network device to provide to an administrator console/program or via Transaction Language 1 (TL1) commands, TL1 being a long-established command language used to program responses and commands between telecommunication network elements.

Each TU-R 122 in a system may be coupled with a TU-C (TU Central) in a Central Office (CO) or other central location. TU-C 142 is located at an Access Node (AN) 114 in Central Office 146. A Management Entity 144 likewise maintains an MIB of operational data pertaining to TU-C 142. The Access Node 114 may be coupled to a broadband network 106 or other network, as will be appreciated by those skilled in the art. TU-R 122 and TU-C 142 are coupled together by a line (loop) 112, which in the case of ADSL may be a twisted pair line, such as a telephone line, which may carry other communication services besides DSL based communications. Either Management Entity 124 or Management Entity 144 may implement and incorporate a diagnostic/management device 170, as described herein. The diagnostic/management device 170 may be operated by a service provider or may be operated by a third party, separate from the entity which provides DSL services to end-users. Thus, in accordance with one embodiment diagnostic/management device 170 is operated and managed by an entity which is separate and distinct from a telecommunications operator responsible for a plurality of digital communication lines. Management Entity 124 or Management Entity 144 may further store collected WAN information and collected LAN information within an associated MIB.

Several of the interfaces shown in FIG. 1 are used for determining and collecting probe and/or operational data. The Q interface 126 provides the interface between the Network Management System (NMS) 116 of the operator and ME 144 in Access Node 114. Parameters specified in the G.997.1 standard apply at the Q interface 126. The near-end parameters supported in Management Entity 144 may be derived from TU-C 142, while far-end parameters from TU-R 122 may be derived by either of two interfaces over the UA interface. Indicator bits and EOC messages may be sent using embedded channel 132 and provided at the Physical Medium Dependent (PMD) layer, and may be used to generate the required TU-R 122 parameters in ME 144. Alternately, the Operation, Administration and Maintenance (OAM) channel and a suitable protocol may be used to retrieve the parameters from TU-R 122 when requested by Management Entity 144. Similarly, the far-end parameters from TU-C 142 may be derived by either of two interfaces over the U-interface. Indicator bits and EOC message provided at the PMD layer may be used to generate the required TU-C 142 parameters in Management Entity 124 of NT unit 108. Alternately, the OAM channel and a suitable protocol may be used to retrieve the parameters from TU-C 142 when requested by Management Entity 124.

At the U interface, there are two management interfaces, one at TU-C 142 (the U-C interface 157) and one at TU-R 122 (the U-R interface 158). Interface 157 provides TU-C near-end parameters for TU-R 122 to retrieve over the line 112. Similarly, U-R interface 158 provides TU-R near-end parameters for TU-C 142 to retrieve over the U interface/loop/line 112. The parameters that apply may be dependent upon the transceiver standard being used (for example, G.992.1 or G.992.2). The G.997.1 standard specifies an optional Operation, Administration, and Maintenance (OAM) communication channel across the U interface. If this channel is implemented, TU-C and TU-R pairs may use it for transporting physical layer OAM messages. Thus, the TU transceivers 122 and 142 of such a system share various operational data maintained in their respective MIBs.

Generally, the diagnostic methods and systems described herein may be performed at any point with the network architecture 100. As shown in FIG. 1, either or both ends of the line 112, include SELT and DELT data collection. For example, in one embodiment, a signal generator and data collector for measuring a SELT parameter at one of the two ends of the line 112 is disposed at the CO side (TU-C 142). In an alternate embodiment, the signal generator and data collector for measuring a SELT parameter at one of the two ends of the line 112 is disposed at the CPE side (TU-R 122). A data collector for collecting a DELT line transfer function measurement performed by transmission from an opposite end of the line 112 may similarly be disposed at either or both ends of the line 112. As further illustrated in FIG. 1, the SELT/DELT data generated for the line 112 is relayed from the measurement data collector to the diagnostic/management device 170. The diagnostic/management device 170 then performs one or more of the methods described herein to analyze the SELT/DELT data received for a given line 112 to arrive at an estimation of one or more line parameters, such as but not limited to detection of one or more line faults.

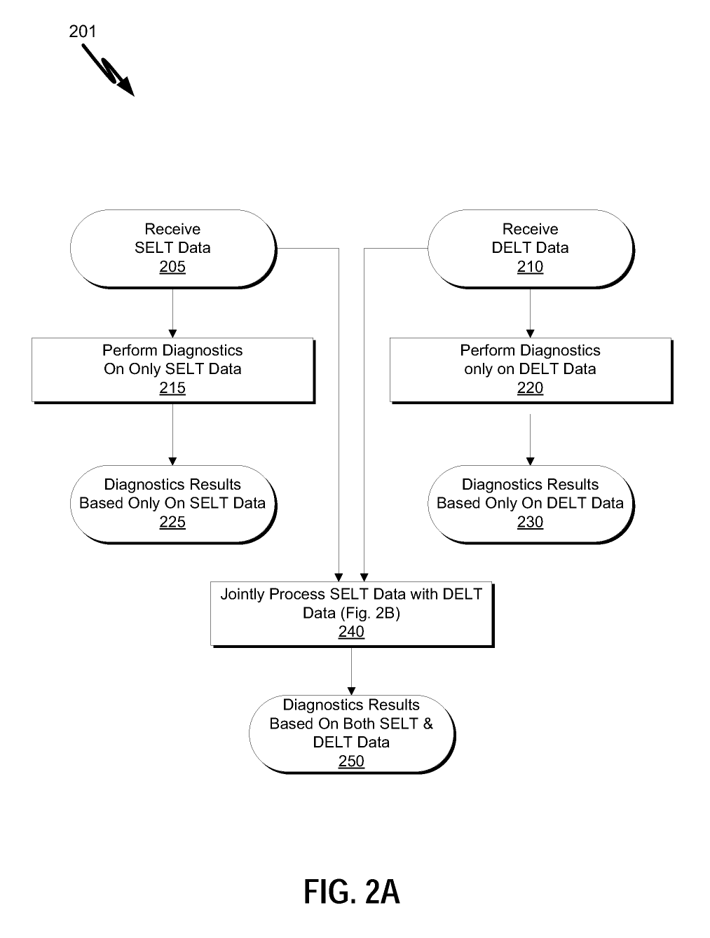

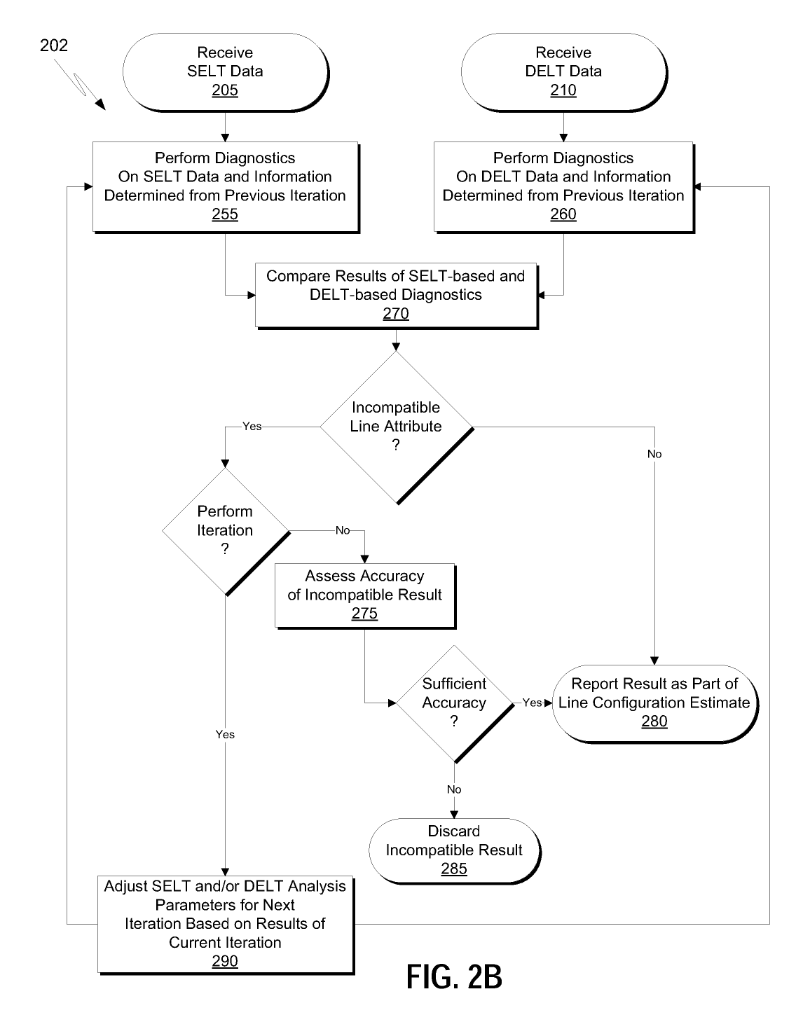

FIG. 2A is a flow diagram illustrating an automated line diagnostics method 201 including joint processing of SELT and DELT data, in accordance with an embodiment of the present invention. Generally, embodiments illustrated by FIG. 2A leverage the individual strengths of SELT and DELT data received at operations 205, 210, and the respective analysis performed at operations 215 and 220, to improve detection capability and accuracy. As such, three determinations are made via analysis of the SELT and DELT data with diagnostic results output at operation 225 based only on SELT data, diagnostic results output at operation 230 based only on DELT data, and diagnostic results are output at operation 250 based on joint processing of SELT and DELT data at operation 240.

The joint processing of SELT and DELT data at operation 240 improves diagnostic capability first with improved fault detection capability. Recognizing that some faults are better detected through one or other of SELT and DELT data, at a minimum joint processing offers the benefit of additive detection capability. For example, because short bridged taps do not affect DELT data as much as they do SELT data, joint processing of SELT data with DELT data improves the detection capability for short bridged taps over that of DELT-based diagnostics alone. Similarly, fault localizing (the act of estimating the distance from an end of the line where a detected fault is) capability is improved beyond that of SELT if jointly processed with DELT data.

The joint processing SELT and DELT data at operation 240 however does not merely result in an additive effect because, as described further herein, the SELT and DELT data analysis may each be adjusted in view of their concurrent analysis of a same line to effectively increase the detection sensitivity of each analysis technique without sacrificing accuracy to the extent that would otherwise occur in lieu of joint processing. In one capacity therefore, joint processing entails employing SELT (DELT) data to prevent false positives (i.e., detecting a fault which is not real) which might happen if only DELT(SELT) data is employed with a similar detection threshold. With joint processing enabling greater detection sensitivity, faults not having a significant effect in either one SELT or DELT data also become detectable.

FIG. 2B is a flow diagram illustrating a method 202 for joint processing SELT and DELT data to determine a physical configuration of a line, in accordance with an embodiment. The method 202 illustrates one embodiment of the joint processing performed at operation 204 in FIG. 2A. As earlier introduced, SELT data is received at operation 205 and DELT data is received at operation 210. For a given communication line (e.g., twisted pair line 112 in FIG. 1), the SELT data at least includes a TDR echo response, or an FDR echo response, accuracy of the echo response (variance), and a scale factor from which the time domain response may be determined. The SELT data may be collected via any technique known in the art, such as, but not limited to TDR and FDR. The DELT data at least includes one or more parameter from which the transfer function (H) is measured. For example, the DELT data may include measures of line insertion loss and line attenuation, and other measures which are reported per-tone, such as, but not limited to, bit distribution, signal-to-noise ratio (SNR), power spectral density (PSD), quiet line noise (QLN), and fine gains.

At operation 255, the SELT data is analyzed for the purpose of diagnosing physical line parameters. Likewise, at operation 260 physical line parameters are determined based on the DELT data. As shown in FIG. 2B, the operations 255 and 260 are performed independently. Notably, at least one of the SELT data diagnostic algorithm and DELT data diagnostic algorithm employed at operations 255 and 260, respectively, entail one or more line fault detection algorithms. Such algorithms generally include at least one analysis parameter that affects that algorithm's fault detection sensitivity. To further illustrate, where the SELT analysis algorithm entails analysis of a feature in an echo response (e.g., a peak), one exemplary analysis parameter is the detection criteria upon which a line fault is associated with the feature.

One exemplary SELT detection algorithm based on ratio tests to assess relative strengths of features in an echo response is further described elsewhere herein and each of the thresholds described for those ratio tests is another example of an analysis parameter. In other embodiments, where the SELT-based detection algorithm entails matching an echo response to a template stored in a bank of templates, the threshold upon which a particular template is determined to be a sufficient match is an exemplary analysis parameter. Similarly, any line fault detection criteria employed by the DELT data-based diagnostic algorithm is an example of an analysis parameter in the context of the present invention. Any SELT data-based diagnostic algorithm known in the art and having one or more analysis parameter that affects the algorithm's detection sensitivity may be utilized at operation 255. Similarly, any DELT data-based diagnostic algorithm known in the art and having one or more analysis parameter that affects an algorithm's detection sensitivity may be utilized at operation 260.

At operation 270, the results generated by the SELT-based diagnostics operation 255 are compared to the results generated by the DELT-based diagnostics operation 260. Operation 270 entails comparing line parameter estimates generated by operations 255 and 260 and classifying those attributes as compatible or incompatible with each other. Generally, this comparison is performed only for the subset of line parameters that are estimated by both SELT and DELT-based diagnostics. In other words, if the two diagnostics may potentially yield the same result, the comparison is to determine if a same or otherwise consistent result was yielded for a particular line. The line attributes that are to be compared at operation 270 are therefore dependent on the diagnostic algorithms employed at operations 260 and 270. As such, any attribute known in the art to be discernible through both a SELT-based diagnostic and a DELT-based diagnostic may be compared at operation 270. Such line attributes, include, but are not limited to, a line length, a detection of any of a series fault (e.g., bad splice); a shunt fault; a bridged-tap; a faulty microfilter, a location of the fault, and additional attributes of the fault, e.g., severity or length of a detected fault.

As one example, where two bridged taps are detected by SELT-based diagnostic operation 255 and one bridged tap of a certain length is estimated by the DELT-based diagnostic operation 260, one bridged tap having been verified through both diagnostic techniques is declared to be a compatible attribute of the SELT-based and DELT-based line configuration estimates. In contrast, the second bridged tap not detected by the DELT-based diagnostics is identified as an incompatible attribute.

For any attributes identified as incompatible, such as the unverified detection of the second bridged tap described in the above example, the method 202 proceeds to determine if a subsequent iteration of one or both of the SELT-based and DELT-based diagnostic operations 255 and 260 is to be performed. This determination may be based on parameters controlling the automated execution of the method 202. In one embodiment, the determination is based on a number of iterations thus far performed on a given set of SELT and DELT data for a line. For example, if less than a threshold number of iterations have been performed, the method 202 proceeds to operation 290 in preparation for performing an additional iteration. In another embodiment, the determination to proceed to operation 290 is based on a value of one or more of the analysis parameters employed in the SELT-based or DELT-based diagnostics performed at operations 255, 260. For example, where a threshold controlling detection of the attribute identified as incompatible is not yet at the limit of a predetermined range, the method 202 proceeds to operation 290 for a further iteration of the method 202 with the detection threshold adjusted appropriately within the predetermined range.

Where the method 202 is to proceed to operation 290, one or more analysis parameters employed in at least one of the SELT or DELT-based diagnostic algorithms is adjusted. Such adjustments may be made to address concurrently a plurality of line attributes identified as incompatible or such adjustments may be made to address a given one of the plurality so as to attempt to serially eliminate the attributes identified as incompatible. In either case, the iterative process may arrive at an estimation of the line configuration with relatively more compatible results and a higher confidence of a correct line diagnosis.

While an analysis parameter adjustment may take different forms dependent on the attribute identified as incompatible, the analysis parameter is in the exemplary embodiment adjusted toward eliminating the incompatible attribute identified during the prior iteration. For example, an adjustment may be made toward eliminating a potential type-I error where one of the SELT-based or DELT-based analyses failed to detect a true fault. In one such embodiment, a line fault detection threshold employed in the SELT or DELT analysis is adjusted so as to increase the detection sensitivity of a fault not detected by that analysis in a prior iteration. For the example where the DELT-based analysis at operation 260 did not detect the second bridged tap, bridged tap detection criteria employed by the DELT-based analysis are adjusted by a predetermined amount to increase bridged tap sensitivity. This increase may be performed incrementally with each iteration of the method 202 until either a limit in the bridged tap detection sensitivity is reached or a compatible result is obtained.

Alternatively, an adjustment may be made toward eliminating a potential type-II error where one of the analyses detected a non-existent fault. In one such embodiment, a line fault detection threshold employed in one of the SELT or DELT analysis is adjusted so as to decrease the detection sensitivity of a fault detected in a prior iteration. For the example, where the DELT-based analysis at operation 260 did not detect the second bridged tap, bridged tap detection criteria employed in the SELT-based analysis are adjusted by a predetermined amount to decrease bridged tap sensitivity.

In further embodiments, determination of how a SELT-based analysis or DELT-based analysis parameter is to be adjusted depends on a predetermined bias for one or the other with respect to a given incompatible attribute. For the example where the DELT-based analysis at operation 260 did not detect the second bridged tap, a bias that SELT-based data is better suited for detecting bridged taps of short length favors adjusting a parameter at operation 290 in a manner that will increase the bridged tap detection sensitivity of the DELT-based analysis rather than reduce the bridged tap detection sensitivity of the SELT-based analysis.

Upon adjusting one or more of the analysis parameters, the method 202 returns to either or both of the analysis operation 255, 260 to repeat the analysis with the adjusted parameters. If only SELT-based analysis parameters were adjusted, the iteration of the method 202 entails performing only operation 255 (not operation 260), and vice versa if only DELT-based analysis parameters were adjusted. If both SELT-based analysis and DELT-based analysis parameters were adjusted, the iteration of the method 202 entails performing again both operations 255 and 260. Iteration of the method 202 then continues with repeating the comparison at operation 270.

Iteration of the method 202 may proceed to incrementally adjust the analysis parameters within a predetermined range. In embodiments, this predetermined range spans detection criteria threshold that exceeds what could be tolerated if the individual analyses were not compared at operation 270. If the comparison at operation 270 yields any compatible attributes, those attributes are ultimately to be declared as part of a line configuration estimate at operation 280. Though embodiments of the present invention are not particular to the mechanics of the reporting operation 280, it is noted such reporting may be performed in substantial real time as the method 202 identifies attributes as compatible, or may be reported at some time subsequent to the completion of the method 202 when no incompatible attributes remain, or when it is determined that no further iteration is to be done.

Where no further iteration is to be done and one or more incompatible analysis result (e.g., line attribute) remains, a determination is made whether to report out an incompatible result as part of operation 280, or instead discard the result at operation 285. In the exemplary embodiment, at operation 275 an accuracy associated with each of the first or second line configuration estimates is determined with respect to a given incompatible attribute. If one of the SELT data analysis or DELT data analysis is considered to have a sufficiently high accuracy for the incompatible attribute, or if a difference in the accuracies of the SELT and DELT data analysis is sufficiently large, the attribute value having the superior accuracy is reported along with compatible results. Of course, the report of any incompatible result may be distinguished from that of compatible results through a measure of confidence proscribed to each of the results reported.

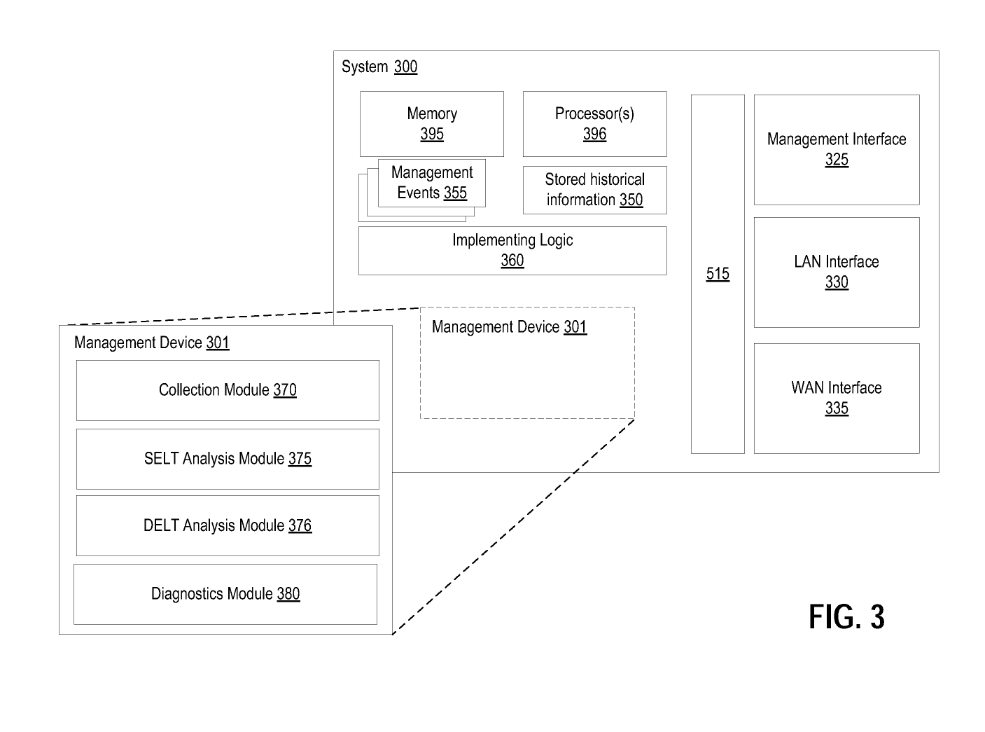

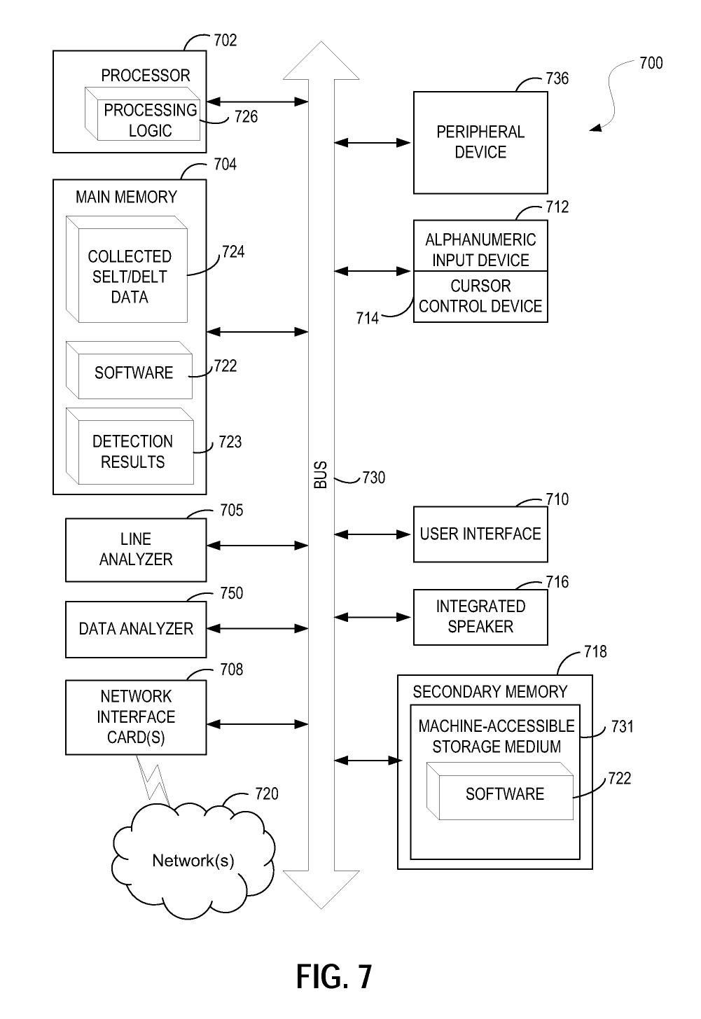

FIG. 3 is a functional block diagram illustrating a system 300 configured to perform joint processing of SELT and DELT data collected from the exemplary network illustrated in FIG. 1, in accordance with an embodiment. Generally, the system 300 is to perform one or more of the methods 201 or 202, described elsewhere herein, in an automated fashion. In the illustrated embodiment, system 300 includes a memory 395 and a processor or processors 396. For example, memory 395 may store instructions to be executed and processor(s) 396 may execute such instructions. Processor(s) 396 may also implement or execute implementing logic 360 to implement the diagnostic algorithms discussed herein. System 300 includes communication bus(es) 315 to transfer transactions, instructions, requests, and data within system 300 among a plurality of peripheral devices communicably interfaced with one or more communication buses 315 (e.g., as further illustrated in FIG. 7). System 300 further includes management interface 325, for example, to receive analysis requests, return diagnostic results, and otherwise interface with the network elements illustrated in FIG. 1.

In embodiments, management interface 325 communicates information via an out-of-band connection separate from DSL line based communications, where “in-band” communications are communications that traverse the same communication means as payload data (e.g., content) being exchanged between networked devices. System 300 further includes DSL line interface 330 to communicate information via a LAN based connection, to monitor connected lines (e.g., line 112 in FIG. 1). System 300 may further include multiple management events 355, any of which may be initiated responsive to analysis of the vectored and non-vectored lines. For example, additional diagnostics, SELT and DELT measurement probes, and the like may be specified and triggered as management events 355. Stored historical information 350 (e.g., SELT/DELT line data) and management events 355 may be stored upon a hard drive, a persistent data store, a database, or other memory/storage location within system 300.

Within system 300 is a line diagnostic and management device 301 which includes a data collection module 370 to collect SELT and DELT data received for a line, a SELT analysis module 375, a DELT analysis module 376, and a diagnostics module 380. The line diagnostic and management device 301 may be installed and configured in a compatible system 300 as is depicted by FIG. 3, or provided separately so as to operate in conjunction with appropriate implementing logic or other software (such as system 600). In any configuration the diagnostic and management device 301 may be implemented within the network architecture 100 (FIG. 1), for example as component of the management device 170.

In accordance with one embodiment, collection module 370 collects SELT and DELT data from interfaced digital communication lines over the interface 330 or from other network elements via management interface 325. Analysis modules 375, 376 analyze the information retrieved via collection module 570 with each of the SELT analysis module 375 and DELT analysis module 376 to apply at least one line fault detection algorithm to output line configuration estimates based on the SELT data or the DELT data, respectively.

The diagnostics module 380 is further coupled to the analysis modules 375, 376 to receive and compare the results of the SELT and DELT analysis, for example comparing attributes of the respective line configurations to determine at least one attribute to be either compatible or incompatible. Where incompatible attributes are identified, at least one of the analysis modules is to modify at least one of the SELT or DELT analysis (e.g., by modifying a detection threshold or other analysis parameter in a predetermined manner substantially as described elsewhere herein), toward eliminating the incompatible attribute. The analysis module may be instructed to adjust one or more of their parameters where the SELT and DELT analysis modules 375, 376 arrive at a different estimate of one or more of: a line length; a location or length of a detected fault; or a different detection/categorization of a fault such as: a series fault; a shunt fault; a bridged-tap; a bad splice; or a faulty microfilter. In further embodiments, where the SELT analysis module 375 processes an echo response, the SELT analysis module is to perform the signal processing of the echo response substantially as described elsewhere herein to cancel an effect of a line attribute, such as a straight length of line, identified in a line configuration estimate.

Where a line attribute is identified by both the SELT and DELT analysis modules 375, 376 (e.g., the line configuration estimates output by each include an estimation that a same fault is present), the diagnostic module is to identify that compatible attribute in an estimation of the physical configuration of the line. This estimation may then be output as a diagnostic report or otherwise made accessible at one or more node in the network architecture 100 (FIG. 1).

In further embodiments, the diagnostics module 380 is to compare an accuracy associated with each of the first or second analysis output by the analysis modules 375, 376 with respect to an incompatible attribute. For example, accuracies may be compared to each other or to a threshold to substantially as described elsewhere herein as part of a determination whether to further identify any attributes deemed incompatible as a line estimation published to one or more node of the network architecture 100, or otherwise made externally available.

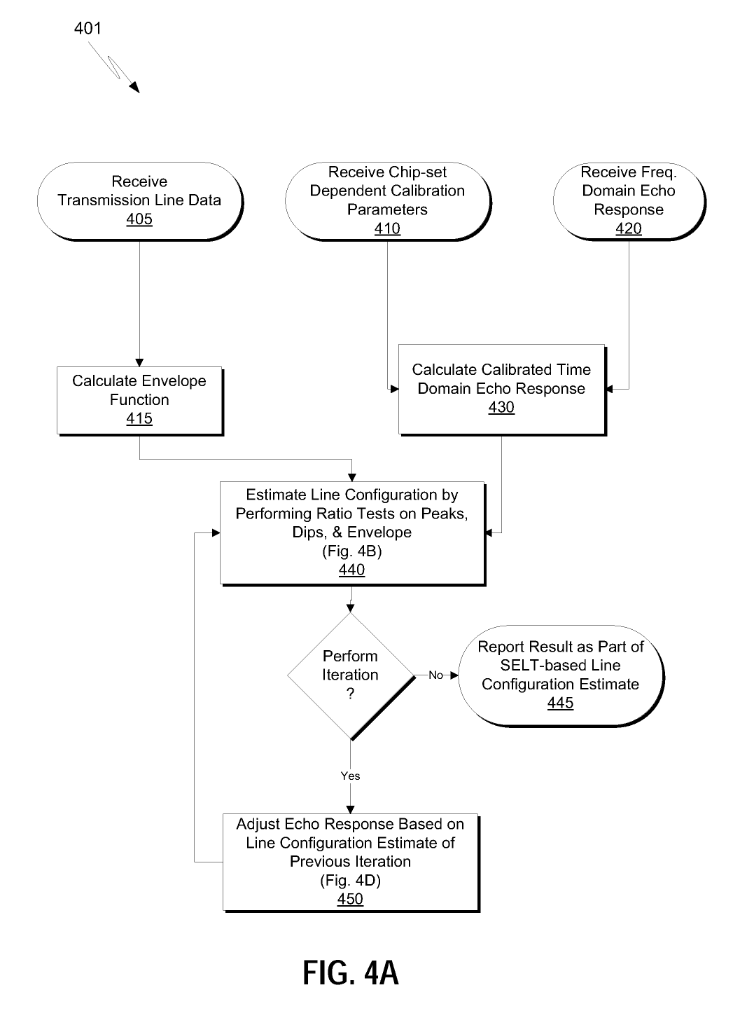

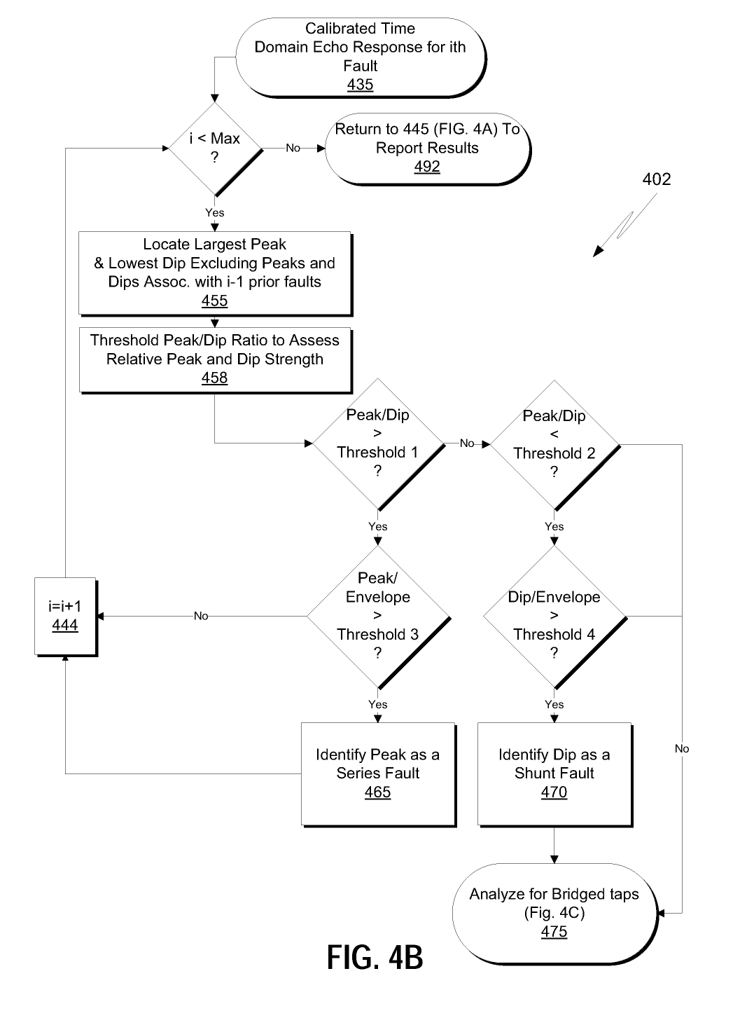

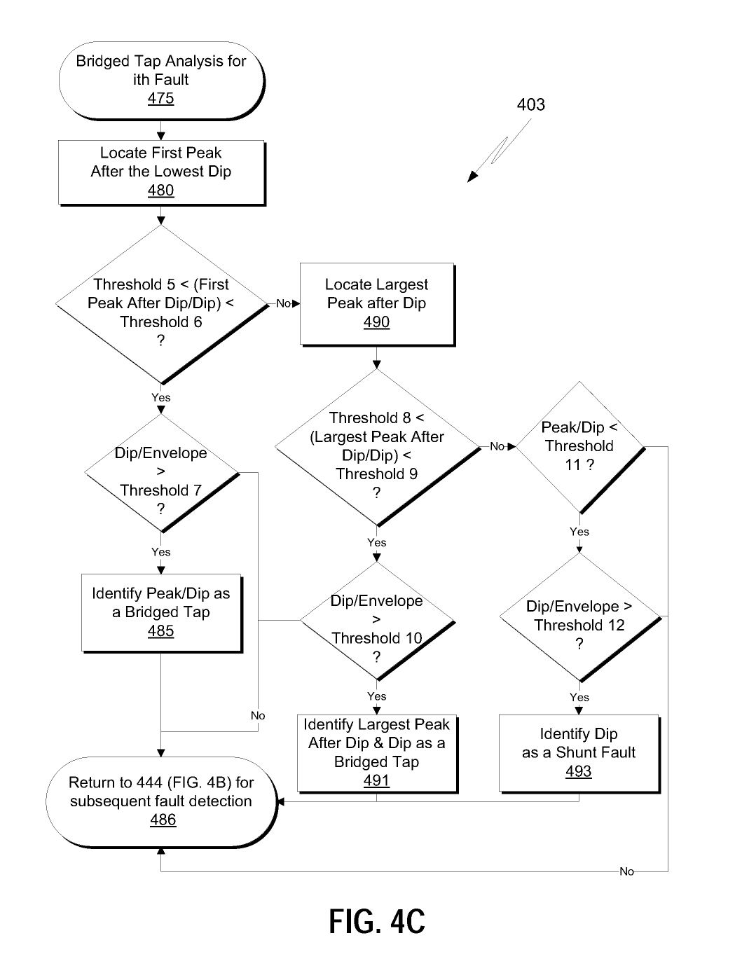

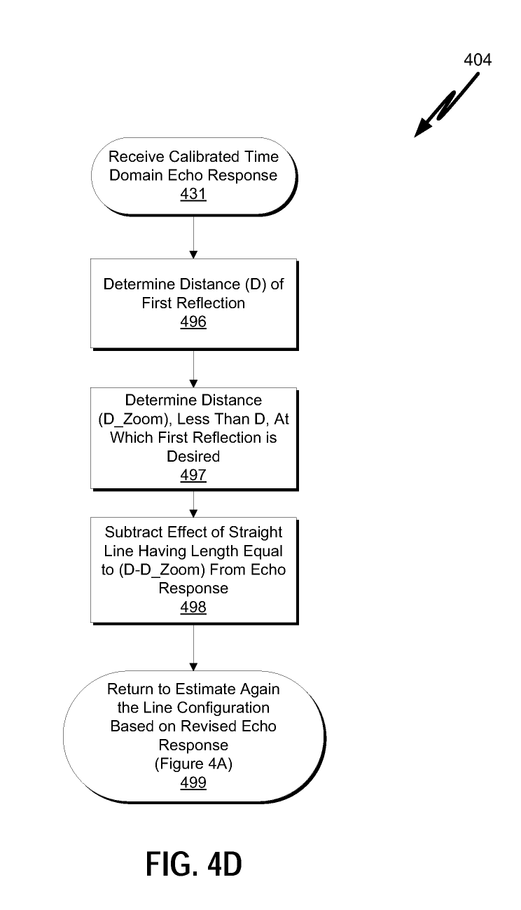

FIG. 4A is a flow diagram illustrating an iterative SELT diagnostic method 401 assessing relative strengths of features in a time domain echo response to detect a large number of line configurations with multiple faults without the complexity of methods employing banks of configuration templates. In a first embodiment, the SELT diagnostic method 401 is employed as a stand-alone line diagnostic which may be applied to any SELT data collected from the CO-side or CPE-side of a line. In the exemplary embodiment, the SELT diagnostic method 401 is performed at the SELT diagnostic operation 255 in the method 202 of FIG. 2B.

As one input, the SELT diagnostic method 401 receives transmission line data at operation 405. The transmission line data may be derived from any transmission line parameters, such as, but not limited to ABCD parameters determined for the line through any conventional measurement technique. The transmission line data includes, but is not limited to characteristic impedance and propagation constant and/or RLCG characterization of the transmission line from which an envelope function of the line is to be calculated at operation 415. Notably, the envelope function may also be determined based on ABCD parameters estimated for a line given certain line characteristics known from field data (e.g., a wire gauge of 26, etc.).

The envelope function is a relationship of the line propagation constant with respect to line distance and is to serve as a reference in the method 401. The reference envelope function may be a reflection expected if an open loop, a short, or a known fault was present in the line at a certain distance from the measure point. In one embodiment where the envelope function represents a reflection expected if an open loop was present in the line at a certain distance from the measurement point, calculation of the envelope proceeds as:

envelope(d)=ifft(e^{-2γd}) (Eq. 1)

where d is the distance, γ is the propagation constant for a given line, and ifft(.) represents the inverse Fourier transform.

In further embodiments, frequency windowing and/or normalization is further applied to adjust Eq. 1. Generally, the windowing filer and/or normalization scale is to be the same as that applied in calculation of the time domain echo response at operation 430. Filtering the transmission line data smoothens out ripples when transformed into the time domain, reducing inverse Fourier transform artifacts. Generally, any frequency filter design known in the art may be employed to this end. Normalization is performed, for example, to adjust dynamic range of the envelope function to match that of the time domain echo response at operation 430 (e.g., to be between 0 and 1) and thereby facilitate the ratio tests subsequently performed in method 401.

As a second input to the SELT diagnostic method 401, chip-set dependent calibration parameters are received as an input at operation 410. Such calibration parameters describe the frequency behavior of the measurement device (e.g., a CO-modem) and fixed front end (e.g., test leads or bus) coupling the measurement device to the line at the measurement point. Techniques for determining such calibration parameters, for example through shorted, loaded, and opened measurements, are known in the art and embodiments of the present invention are not limited in this respect.

As a third input to the SELT diagnostic method 401, a frequency domain echo response is received as measurement data collected at operation 420 in response to excitation signals applied to the line at the measurement point. The received calibration parameters are utilized to arrive at a calibrated time domain echo response at operation 430. In the time domain, impedance changes associated with features of a line can be detected. Many techniques for arriving at a calibrated time domain echo response from a frequency domain echo response are known in the art. A time domain echo response may also be directly provided as an input to the method 401.

In embodiments, frequency windowing and/or normalization is applied to a frequency domain echo response (e.g., as received at operation 420) to arrive at the calibrated time domain echo response at operation 430. In the exemplary embodiment, the windowing filter and normalization scale is the same as those applied in calculation of the reference envelope function at operation 430.

At operation 440, the line configuration is estimated based on a comparison of strengths of peaks and dips detected in the calibrated time domain echo response relative to the envelope function evaluated at the distances associated with the peaks and dips, and relative to each other. As described further elsewhere herein in the context of FIGS. 4A and 4B, relative strengths of peaks and dips, peaks and envelope, and dips to envelope are analyzed at operation 440 to detect and/or classify of a variety of faults in a line as an estimate of a line's configuration.

As illustrated in FIG. 4A, upon detection of at least one fault at operation 440, a decision is made to either report out the fault(s) as a part of a SELT-based line configuration estimate at operation 445 or to adjust the echo response based on the currently detected line configuration at operation 450 so as to remove an effect of an attribute from the line through signal processing. As is further described elsewhere herein in the context of FIG. 4D, the signal processing performed at operation 450 is an effort to improve fault detectability in a subsequent iteration of the operation 440 where peak, dip, envelope assessment is repeated for the adjusted echo response. In the exemplary embodiment, the decision to perform an iteration is based on whether a first detected line condition (i.e. fault) is located at a distance further than a pre-defined threshold. If so, the echo response is adjusted, and if not no further iteration is performed.

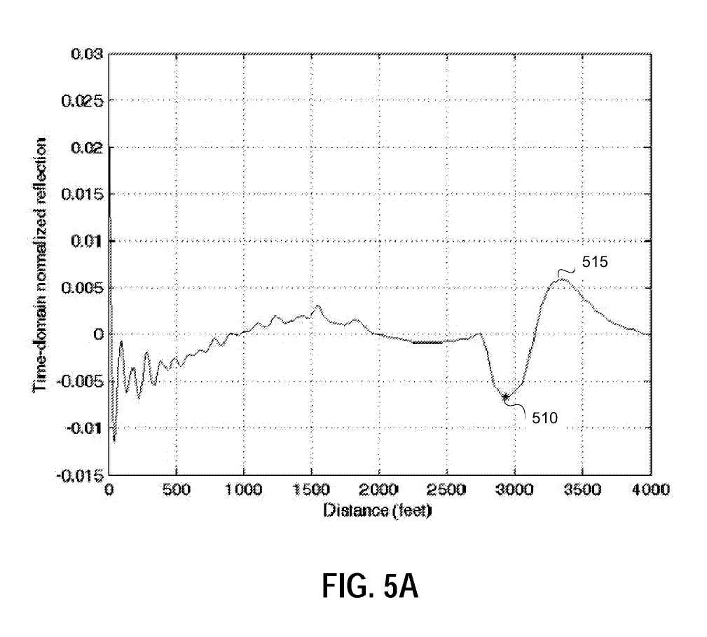

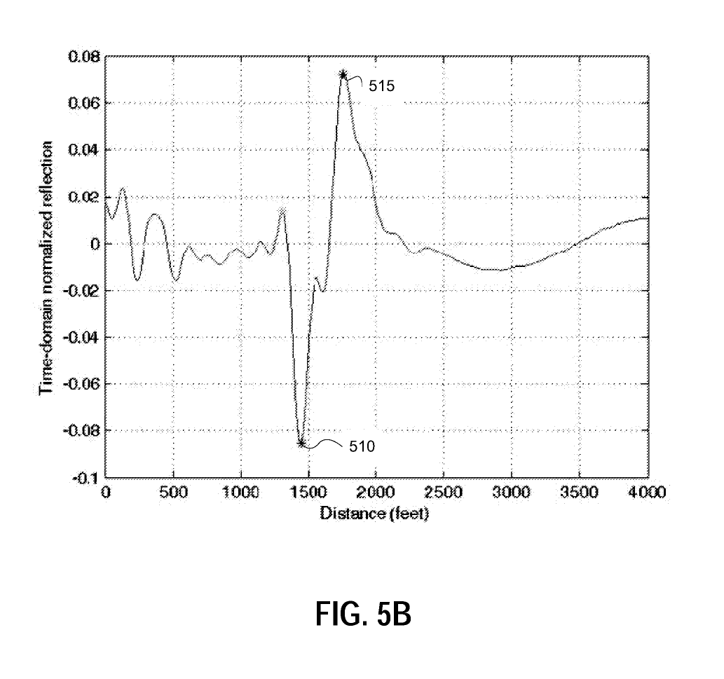

FIG. 4B is a flow diagram illustrating a method 402 for performing peak and dip strength assessments on a time domain echo response. The method 402 begins with receiving the calibrated time domain echo response at operation 435, for example as was determined at operation 430 (FIG. 4A). A predetermined number of detection attempts (e.g., 2-3) are then performed on the same time domain echo response, one or more of which may, but not necessary result in detection and classification of a line condition (fault). Where the number of detection attempts i has reach the predetermined maximum, the method 402 proceeds to operation 492 for return to operation 445 (FIG. 4A) for reporting of results.

Where the number of detection attempts i has reach a predetermined maximum, the method 402 proceeds to operation 455. At operation 455, a peak and a dip of largest magnitude are identified from a subset of peaks and dips in the calibrated time domain echo response that have not already been associated with line faults identified in prior iterations of the method 402. FIG. 5A is an exemplary time domain echo response plotting a time-domain normalized reflection as a function of distance from the measurement point. The point 510 represents amplitude of the lowest dip and the point 515 represents amplitude of a highest peak for an iteration of the method 402.

In embodiments, a strength of a peak relative to that of a dip is determined for the peak/dip pair identified at operation 455. A physical configuration of the line may then be determined based on a thresholding of the relative strengths of the peak and dip amplitude. For example, if the peak or dip is sufficiently dominant and/or large, the peak or dip is associated with a particular line fault. In the illustrated embodiment, relative strengths of a peak and dip pair are assessed on the basis of a “peak-to-dip ratio,” referred to herein as a “PDR,” which is a useful quantity independent of amplitude. For example, in the threshold operation 458 (FIG. 4B), a first PDR is calculated as the magnitude of the amplitude of the peak divided by the amplitude of the dip which may be expressed mathematically as:

$$PDR ≡ \vert \frac{Amplitude ( peak )}{Amplitude ( dip )} \vert . \qquad Eq . ( 2 )$$

The PDR determined at operation 458 for the peak/dip pair 515/510 (FIG. 5) is ˜0.88.

In embodiments, one of the peak/dip pair deemed sufficiently dominant is compared to the envelope function of the line, for example as was determined at operation 415 in FIG. 4A, evaluated at the distance of the peak/dip. In the embodiment illustrated by FIG. 4B, a first threshold (i.e., “threshold 1”) is applied to the PDR. Where the PDR satisfies the first predetermined threshold (e.g., exceeds the threshold 1), the peak is deemed sufficiently dominant and compared to the envelop at the distance d of the peak. If the PDR does not satisfy the first threshold, a second assessment is made to determine if the dip is sufficiently dominant (i.e., sufficiently larger than the peak). For example, the PDR is compared to a second predetermined threshold (i.e., “threshold 2”). Where the PDR satisfies the second threshold (e.g., is below threshold 2), the dip is deemed sufficiently dominant over the peak and the dip is then compared to the envelope at the distance d of the dip. In the exemplary embodiment, the dominant member of the peak/dip pair is compared by thresholding a second ratio. This second ratio is calculated by dividing the dominant member of the peak/dip pair by the envelope to generate either a peak-to-envelope ratio (“PER”) or a dip-to-envelope ratio (“DER”). A PER may be mathematically expressed as:

$$PER ≡ \vert \frac{Amplitude ( peak )}{Envelope ( distance ( peak ) )} \vert , \qquad Eq . ( 3 )$$

with the envelope function in Eq. (1), for example, evaluated to determine the reflection expected if an open loop was at the distance of the peak being evaluated. For the case where the dip is sufficiently dominant (e.g., threshold 1 is not satisfied but threshold 2 is satisfied), an analogous function for the dip is evaluated to calculate the DER.

As further illustrated in FIG. 4B, where the PER satisfies a predetermined threshold, for example, where the PER is greater than a third threshold (“threshold 3”), the peak is associated with a series fault in the line, such as, but not limited to, a bad splice, a corroded connection, or a gauge change to a higher impedance. The series fault is then available for output as a parameter of the diagnosed line configuration, for example to be reported out as a SELT-based line configuration estimate at operation 445 (FIG. 4A). The method 402 then returns to operation 455 for location of a next largest peak/trough pair until the maximum detection iteration count is reached, or until analysis of the next largest peak/trough satisfies another loop exit criteria.

Where the peak is of insufficient strength (e.g., the first PDR fails to satisfy the first threshold) and the dip is also of insufficient strength (e.g., first PDR fails to satisfy the second threshold, or DER fails to satisfy the fourth threshold), the method 402 triggers a further analysis for bridged taps at operation 475 on the basis of the peak/dip pair that was identified at operation 455.

Alternatively, where the PDR comparisons indicate the dip is sufficiently dominant (e.g., threshold 1 is not satisfied but threshold 2 is satisfied), the method 402 proceeds to operation 470 if the DER satisfies a predetermined threshold, for example where the DER is greater than a fourth threshold (“threshold 4”), and the line is diagnosed as having a potential shunt fault such as, but not limited to, a short on the line, poor isolation, water in the cable, or gauge change to lower impedance. In the exemplary embodiment, the association of the dip with a shunt fault at operation 470 is provisional pending a further analysis for bridged taps at operation 475, as described elsewhere herein in the context of FIG. 4C.

FIG. 4C is a flow diagram further illustrating exemplary relative comparisons of peaks and dips performed on a time domain echo response. Such comparisons are performed as a portion of the iterative SELT diagnostic method illustrated in FIG. 4A, in accordance with an embodiment. After being triggered at operation 475, the method 403 proceeds to operation 480, with locating in the time domain echo response a first peak after the dip identified at operation 455 (i.e., the first trailing peak). For the particular echo response shown in FIG. 5A, the point 515 is the amplitude of the peak following the dip associated with point 510 and so operation 480 locates the same peak/dip pair as was identified at operation 455. However, operation 480 may of course identify a new peak as the first trailing peak, different than the main peak that was located at operation 455, as dependent on a given echo response.

In embodiments, the strength of the dip is then assessed relative to the first trailing peak. If the relative strength of the dip falls within a predetermined range, then the line is diagnosed as having a bridged tap and the dip/first trailing peak pair are associated with the bridged tap. In the exemplary embodiment illustrated in FIG. 4C, the strength of the dip is assessed relative to the first trailing peak by first determining a second peak-to-dip ratio (PDR) in the same manner as the first PDR was calculated. This second PDR is then compared to a fifth predetermined threshold (“threshold 5”) and a six predetermined threshold (“threshold 6”). Where the second PDR falls between the fifth and six thresholds, the DER is compared to another predetermined threshold (“threshold 7”). Where DER threshold is satisfied, the dip/first trailing peak pair is associated with a bridged tap on the line at operation 485. If not, no bridged tap determination is made for the ith detection iteration and any provisional association made between the dip and a shunt fault at operation 470 becomes non-provisional and processing returns to method 401 (FIG. 4A) with at least one iteration of 440 now completed. Results from operation 440 are then ready for reporting at operation 445 or the echo response is adjusted at operation 450. In either event, the method 403 then completes at operation 486 by incrementing the iteration count and returning to operation 444 for a subsequent iteration of the method 402 (FIG. 4B).

Alternatively, where the second PDR falls outside of the range defined by the fifth and six thresholds, the method 403 proceeds to operation 490 where the largest trailing peak is detected. For the particular echo response shown in FIG. 5A, the point 515 is the maximum of the largest peak following the dip associated with point 510 and so operation 490 locates the same peak/dip pair as was identified at operation 455 and at operation 490. However, operation 490 may of course identify a new peak as the largest trailing peak, different than the largest peak that was located at operation 455 and different than the first trailing peak that was located at operation 490, as a dependent on a given echo response.

In embodiments, the strength of the dip is then assessed relative to the largest trailing peak. If the relative strength of the dip falls within a predetermined range, then the line is diagnosed as having a bridged tap and the dip/largest trailing peak pair are associated with the bridged tap. In the exemplary embodiment illustrated in FIG. 4C, the strength of the dip is assessed relative to the largest trailing peak by first determining a third peak-to-dip ratio (PDR) in the same manner as the first and second PDR. This third PDR is then compared to an eighth predetermined threshold (“threshold 8”) and eighth ninth predetermined threshold (“threshold 9”). Where the third PDR falls between the seventh and eighth thresholds, the DER is compared to another predetermined threshold (“threshold 10”). Where DER threshold is satisfied, the dip/largest trailing peak pair is associated with a bridged tap on the line at operation 491. If not, no bridged tap determination is made for the ith detection iteration and any provisional association made between the dip and a shunt fault at operation 470 becomes non-provisional and processing returns to method 401 (FIG. 4A) with at least one iteration of 440 now completed. Results from operation 440 are then ready for reporting at operation 445 or the echo response is adjusted at operation 450. In either event, the method 403 then completes at operation 486 by incrementing the iteration count and returning to operation 444 for a subsequent iteration of the method 402 (FIG. 4B).

Alternatively, where the third PDR falls outside of the range defined by the seventh and eighth thresholds, and the strength of the dip relative to the largest trailing peak is sufficient, the dip is compared to the envelope (potentially a second time). If the dip is sufficiently dominant, the line is diagnosed with a shunt fault. For example, as shown in FIG. 4C, the third PDR is compared to another predetermined threshold (“threshold 11”) and if the dip is sufficiently dominant, the ninth threshold is satisfied (e.g., PDR is smaller than the ninth threshold). A dip-to-envelope ratio (DER) is then calculated, substantially as described elsewhere in the context of a PER, and compared to another threshold (“threshold 12”). If the dip satisfies this threshold (e.g., DER exceeds threshold 12), the dip is associated with a shunt fault on the line at operation 493. If not, no bridged tap determination is made for the particular detection iteration and any provisional association made between the dip and a shunt fault at operation 470 becomes non-provisional and processing returns to method 401 (FIG. 4A) with at least one iteration of 440 now completed. Results from operation 440 are then ready for reporting at operation 445 or the echo response is adjusted at operation 450. In either event, the method 403 then completes at operation 486 by incrementing the iteration count and returning to operation 444 for a subsequent iteration of the method 402 (FIG. 4B).

FIG. 4D is a flow diagram illustrating a method 404 for adjusting the echo response based on the estimation of the physical configuration that is performed. The method 404 may be applied within the context of any line diagnostic based on SELT. Generally, the method 404 is useful for improving detectability of faults dynamically as a line is diagnosed. As such, in the exemplary embodiment the method 404 is implemented to process the time domain echo response between iterations of the method 404 (FIG. 4A). With the method 404, an effect of a line attribute identified in a previous estimation of the physical configuration, or derived from the previous estimation of the physical configuration, is removed. Generally, the effect of any attribute of the line configuration may be removed, such as but not limited to lengths of straight line and detected faults (e.g., any of the faults detected in methods 402, 403). Removal of detected faults however poses relatively more risk of propagating a detection error.

The method 404 begins with the received calibrated time domain echo response input at operation 431. In the exemplary embodiment where the attribute to be removed is a length of straight line, a distance (D) of a first reflection is identified at operation 496. In the exemplary embodiment where the method 404 is performed at operation 450 (FIG. 4A), the first reflection has been identified at operation 440 for the current iteration of method 401. For example, as shown in FIG. 5A, the first reflection is the dip 515 with the distance D being approximately 2950 feet (ft).

At operation 497, if the distance D is greater than a predetermined threshold (e.g., 500 ft) a distance D_Zoom, that is no greater than the distance D, is selected at which the first reflection is desired to appear (e.g., at the threshold distance of 500 ft). At operation 498, the effect of a straight line having a length equal to D-D_Zoom is subtracted from the time domain echo response under the assumption that over this distance D-D_Zoom, the line is straight (i.e., faultless). Generally, any known signal processing technique for removing a length of straight line may be applied. For example, in the exemplary embodiment, the echo response is processed to compensate for the effect of the straight line as follows:

echo(f)=echo(f)*(1+tan h(γΔ))/(1−tan h(γΔ)), Eq. (4)

where echo(f) denotes the echo response at frequency f, Δ=D−D_Zoom denotes the length of the straight line effect of which will be cancelled, and γ denotes the propagation constant.

FIG. 5B is the exemplary calibrated time domain echo response illustrated in FIG. 5A after having an effect of approximately 1500 feet of straight line removed. As shown, the dips and peaks corresponding to points 510, 515 are now more prominent and in better condition for further analysis. For example, as shown in FIG. 4D, the method 404 completes by returning the revised echo response to the method 401 (FIG. 4A) for the peak/dip strength assessments and based on ratio tests.

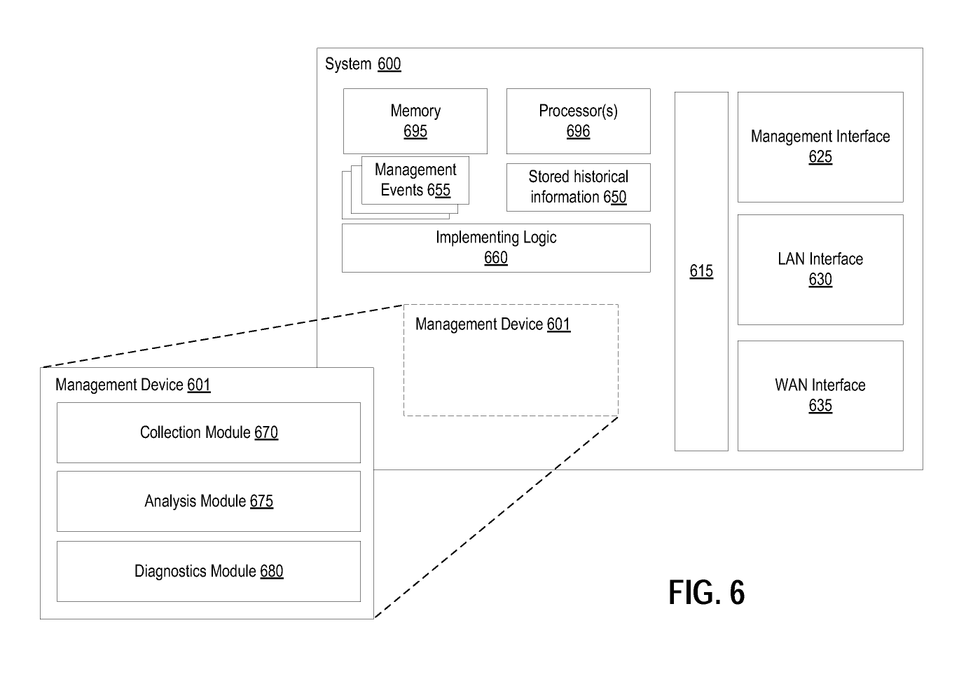

FIG. 6 is a functional block diagram illustrating a system 600 configured to characterize a physical configuration of a twisted pair telephone line based on analysis of SELT data collected from the exemplary network illustrated in FIG. 1, in accordance with an embodiment. Generally, the system 600 is to perform one or more of the methods 401, 402, 403 or 404, described elsewhere herein, in an automated fashion. In further embodiments, the system 600 may be incorporated with the system 300, described elsewhere herein, as an integrated line diagnostic system.

In the illustrated embodiment, system 600 includes a memory 695 and a processor or processors 696. For example, memory 695 may store instructions to be executed and processor(s) 696 may execute such instructions. Processor(s) 696 may also implement or execute implementing logic 660 to implement the diagnostic algorithms discussed herein. System 600 includes communication bus(es) 615 to transfer transactions, instructions, requests, and data within system 600 among a plurality of peripheral devices communicably interfaced with one or more communication buses 615 (e.g., as further illustrated in FIG. 7). System 600 further includes management interface 625, for example, to receive analysis requests, return diagnostic results, and otherwise interface with the network elements illustrated in FIG. 1.

In embodiments, management interface 625 communicates information via an out-of-band connection separate from DSL line based communications, where “in-band” communications are communications that traverse the same communication means as payload data (e.g., content) being exchanged between networked devices. System 600 further includes DSL line interface 630 to communicate information via a LAN based connection, to monitor connected lines (e.g., line 112 in FIG. 1). System 600 may further include multiple management events 655, any of which may be initiated responsive to analysis of the vectored and non-vectored lines. For example, additional diagnostics, SELT and line transmission measurement probes, and the like may be specified and triggered as management events 655. Stored historical information 650 (e.g., SELT/DELT line data) and management events 655 may be stored upon a hard drive, a persistent data store, a database, or other memory/storage location within system 600.

Within system 600 is a line diagnostic and management device 601 which includes a data collection module 670 to collect SELT data and line transmission data received for a line, an analysis module 675, and a diagnostics module 680. The line diagnostic and management device 601 may be installed and configured in a compatible system 600 as is depicted by FIG. 6, or provided separately so as to operate in conjunction with appropriate implementing logic or other software (such as system 300).

In accordance with one embodiment, collection module 670 collects SELT data and line transmission data from interfaced digital communication lines over the interface 630 or from other network elements via management interface 625 and stores the data to a memory. The analysis module 675 communicatively coupled to the collection module 670 analyzes the information retrieved via collection module 670. For example, in an embodiment the analysis module 675 is to determine a calibrated time domain echo response from a frequency domain echo response received from the collection module 670 for the line under analysis. In further embodiments, the analysis module 675 is to calculate an envelope function from transmission line data received for the line under analysis. The diagnostics module 680 is further coupled to the analysis module 675, to receive a characterization of features and/or parameters identified by processing the data for a line and to compare a size of at least one peak relative to that of at least one dip in the time domain echo response; and to determine a physical configuration of the line based on the size comparison between the peak and dip.

In embodiments, the diagnostics module 680 is to compare a size of at least one peak or at least one dip to the envelope function determined by the analysis module 675 and to determine a physical configuration of the line based on the size comparison between the envelope and the peak or dip, substantially as described elsewhere herein. For example, in one embodiment the diagnostics module 680 is to identify a highest peak from a set of peaks in the time domain echo response not yet associated with a line attribute, identify a lowest dip from a set of dips in the echo response not yet associated with a line attribute, and the distinguish between a series fault and a shunt fault based on a size of the highest peak relative to that of the lowest dip. As another example, the diagnostics module 680 may be further configured to identify, in the time domain echo response, a first trailing peak after the lowest dip not yet associated with a line fault and compare a size of the lowest dip to a size of the first trailing peak, substantially as described elsewhere herein. The diagnostics module 380 may then output a determination of a bridge tap or a shunt fault based on the size comparison between the first trailing peak and the lowest dip.

In still other embodiments, the diagnostics module 380 is to identify, in response to determining the first trailing peak relative to the lowest dip is not within a first predetermined range, a highest trailing peak after the lowest dip. The diagnostics module 380 may further be configured to determine a size of the largest trailing peak relative to the lowest dip and where the relative size of the largest trailing peak relative to the lowest dip is within a predetermined range, the highest trailing peak and the lowest dip is identified by the diagnostics module 380 as corresponding to a bridged-tap. Any such diagnostic results may then be stored or forwarded to a location accessible one or more mode of the network architecture 100.

In further embodiments, the analysis module 675 is to iteratively adjust the calibrated time domain echo response based on an estimation of the physical configuration of the line output from the diagnostics module 680. For example where the diagnostics module 680 is executing the method 401, and identifies a fault at a given distance, the analysis module 675 may subject the SELT data to single processing techniques to cancel an effect of a length of straight line from the time domain echo response as determined based on the distance of a reflection in the echo response corresponding to the identified fault. The time domain echo response, as processed by the analysis module 675 is then output again to the diagnostics module 380 for a subsequent iteration of peaks and dips, for example using the ratio tests described herein.

FIG. 7 illustrates a diagrammatic representation of a computer system 700 in the exemplary form of a computer system, in accordance with one embodiment, within which a set of instructions, for causing the computer system 700 to perform any one or more of the methodologies discussed herein, may be executed. In alternative embodiments, the machine may be connected, networked, interfaced, etc., with other machines in a Local Area Network (LAN), a Wide Area Network, an intranet, an extranet, or the Internet. The computer system 700 may operate in the capacity of a server or a client machine in a client-server network environment, or as a peer machine in a peer-to-peer (or distributed) network environment. Certain embodiments of the machine may be in the form of a personal computer (PC), a set top box (STB), a web appliance, a server, or any machine known in the art capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 700 includes a processor 702, a main memory 704 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 718 (e.g., a persistent storage device including hard disk drives and persistent data base implementations), which communicate with each other via a bus 730. Main memory 704 includes information and instructions and software program components necessary for performing and executing the functions with respect to the various embodiments of the systems, methods, and DSM server as described herein. Optimization instructions 723 may be triggered based on, for example, analysis of neighborhood information, SNR data, PSD data, noise levels with mitigation active and noise levels with mitigation inactive, and so forth. Collected SELT/DELT, and line transmission data and calculations 724 are stored within main memory 704. Line configuration results as well as optimization instructions 723 may be stored within main memory 704. Main memory 704 and its sub-elements (e.g. 723 and 724) are operable in conjunction with processing logic 726 and/or software 722 and processor 702 to perform the methodologies discussed herein.

Processor 702 represents one or more general-purpose processing devices such as a microprocessor, central processing unit, or the like. Processor 702 may also be one or more special-purpose processing devices such as an application specific integrated circuit (ASIC), a field programmable gate array (FPGA), a digital signal processor (DSP), or the like. Processor 702 is configured to execute the processing logic 726 for automatically performing the operations and functionality which is discussed elsewhere herein (e.g., as methods 201, 202, 401, 402, 403, 404, etc.).

The computer system 700 may further include one or more network interface cards 708 to communicatively interface the computer system 700 with one or more networks 720 from which information may be collected for analysis. The computer system 700 also may include a user interface 710 (such as a video display unit, a liquid crystal display (LCD)), an alphanumeric input device 712 (e.g., a keyboard), a cursor control device 714 (e.g., a mouse), and a signal generation device 716 (e.g., an integrated speaker). The computer system 700 may further include peripheral device 736 (e.g., wireless or wired communication devices, memory devices, storage devices, audio processing devices, video processing devices, etc.).

The computer system 700 may perform the functions of a line analyzer 705 capable interfacing with digital communication lines in vectored and non-vectored groups, monitoring, collecting SELT/DELT data 724, analyzing, and reporting detection results 723, and initiating, triggering, and executing various instructions including the execution of commands and instructions to diagnose a line based on collected SELT/DELT data 724, perform ratio tests on a time domain echo response calculated from SELT data 724, etc.

The secondary memory 718 may include at least one non-transitory machine-readable storage medium (or more specifically a non-transitory machine-accessible storage medium) 731 on which is stored one or more sets of instructions (e.g., software 722) embodying any one or more of the methodologies or functions described herein. Software 722 may also reside, or alternatively reside within main memory 704, and may further reside completely or at least partially within the processor 702 during execution thereof by the computer system 700, the main memory 704 and the processor 702 also constituting machine-readable storage media. The software 722 may further be transmitted or received over a network 720 via the network interface card 708.

The above description is illustrative, and not restrictive. For example, while flow diagrams in the figures show a particular order of operations performed by certain embodiments of the invention, it should be understood that such order may not be required (e.g., alternative embodiments may perform the operations in a different order, combine certain operations, overlap certain operations, etc.). Furthermore, many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. The scope of the invention should, therefore, be determined with reference to the appended claims, along with the full scope of equivalents to which such claims are entitled.

1. A method of characterizing a physical configuration of a twisted pair telephone line, the method comprising:
generating a first line configuration estimate based on an analysis of single-ended line test (SELT) data collected from the line;
generating a second line configuration estimate based on an analysis of double-ended line test (DELT) data collected from the line;
determining at least one attribute of the configuration estimates to be either compatible or incompatible based on a comparison the first and second line configuration estimates;
modifying at least one of the SELT or DELT analysis, respectively, in response to determining at least one attribute is incompatible; and
repeating the comparison after revising one of the first or second line configuration estimates based on the modified SELT or DELT analysis.

2. The method of claim 1, wherein the at least one attribute further comprises at least one of:
a location of a fault;
an identification of a fault as any of:
a series fault;
a shunt fault;
a bridged-tap; or
a length of a bridged-tap.

3. The method of claim 1, further comprising identifying, in an estimation of the physical configuration of the line, at least one attribute determined to be compatible.

4. The method of claim 3, further comprising:
determining an accuracy associated with each of the first or second line configuration estimates with respect to an incompatible attribute;
comparing the accuracies to each other or a predetermined threshold; and
identifying, as a further estimation of the line configuration, the incompatible attribute based on the line configuration estimate having a superior accuracy exceeding the predetermined threshold.

5. The method of claim 1, wherein presence of a line fault identified by only one of the SELT and DELT analysis is determined to be an incompatible attribute;
wherein each of the SELT and DELT analysis comprises a line fault detection algorithm; and
wherein the at least one of the first line configuration estimate or second line configuration estimate is revised after modifying a line fault detection threshold in one of the SELT or DELT analysis toward eliminating the incompatibility.

6. The method of claim 5, wherein the first line configuration algorithm estimate is revised after increasing the fault detection sensitivity of the SELT analysis in response to the DELT analysis detecting the fault, or wherein the second line configuration algorithm estimate is revised after increasing the fault detection sensitivity of the DELT analysis in response to the SELT analysis detecting the fault.

7. The method of claim 1, wherein presence of a line fault detected by only one of the SELT and DELT analysis is identified as an incompatible attribute; and
wherein the first line configuration estimate is revised by modifying the SELT analysis to include signal processing, the signal processing to cancel an effect of a length of straight line identified in the first line configuration estimate.

8. The method of claim 7, wherein the SELT data includes an echo response, and wherein the signal processing is of the echo response and the length of straight line is a predetermined amount less than a distance determined for a first reflection identified in the in first line configuration estimate.

9. The methods of claim 5, wherein the line fault detection threshold comprises a threshold of relative peak-to-envelop, dip-to-envelope or peak-to-dip sizes in a time domain echo response assessed as part of the SELT analysis.

10. A system for characterizing a physical configuration of a twisted pair telephone line, the system comprising:
a memory to store both single-ended line test (SELT) data and double-ended line test (DELT) data collected from the line;
a first analysis module coupled to the memory to generate first line configuration estimate based on an analysis of SELT data;
a second analysis module coupled to the memory to perform an analysis of the DELT data to generate a second line configuration estimate; and
a diagnostics module coupled to the analysis module to:
determine at least one attribute of the configuration estimates to be either compatible or incompatible based on a comparison of the first and second line configuration estimates;
wherein, if at least one attribute is determined incompatible, at least one of the analysis modules is to modify at least one of the SELT or DELT analysis and revise at least one of the first or second line configuration estimates based on the revised analysis, and wherein the diagnostics module is to repeat the comparison of the first or second line configuration estimates after the revising.

11. The system of claim 10, wherein the at least one attribute further comprises at least one of:
a location of a fault;
an identification of a fault as any of:
a series fault;
a shunt fault;
a bridged-tap; or
a length of a bridged-tap.

12. The system of claim 10, wherein, if at least one attribute is determined compatible, the diagnostic module is to identify that compatible attribute in an estimation of the physical configuration of the line.

13. The system of claim 12, wherein the diagnostics module is to determine an accuracy associated with each of the first or second analysis with respect to an incompatible attribute;
wherein the diagnostics module is to compare the accuracies to each other or to a threshold; and
wherein the diagnostics module is to characterize, as a further estimation of the line configuration, the incompatible attribute based the line configuration estimate having the superior accuracy if either the superior accuracy, or a difference in the accuracies, exceeds a predetermined threshold.

14. The system of claim 12, wherein the diagnostics module is to determine presence of a line fault identified by only one of the SELT and DELT analysis to be an incompatible attribute;
wherein the analysis module is to apply a line fault detection algorithm in each of the SELT and DELT analysis; and
wherein the diagnostics module is to revise at least one of the first line configuration estimate or second line configuration estimate after a line fault detection threshold in one of the SELT or DELT analysis is modified toward eliminating the incompatibility.

15. The system of claim 14, wherein the analysis module is to reduce the fault detection sensitivity of the SELT analysis in response to the DELT analysis detecting the fault, or wherein the analysis module is to reduce the fault detection sensitivity of the DELT analysis in response to the SELT analysis detecting the fault

16. The system of claim 12, wherein the diagnostics module is to determine presence of a line fault identified by only one of the SELT and DELT analysis to be an incompatible attribute; and
wherein the analysis module is to modify the SELT analysis to include signal processing of the SELT data, the signal processing to cancel an effect of a length of straight line identified in the first line configuration estimate.

17. The system of claim 16, wherein the SELT data includes an echo response, and wherein the signal processing is of the echo response and the length of straight line is a predetermined amount less than a distance determined for a first reflection in the in first line configuration estimate.

18. At least one non-transitory computer readable medium comprising instructions thereon, that when executed by a processor cause a computer to perform the method of claim 1.

19. A system for characterizing a physical configuration of a twisted pair telephone line, the system comprising:
a means to receive single-ended line test (SELT) data;
a means to receive double-ended line test (DELT) data collected from the line;
a means to perform an analysis of SELT data and of the DELT data; and
a means to generate a first line configuration estimate based on the SELT analysis;
a means to generate a second line configuration estimate based on the DELT analysis; and
a means to determine at least one attribute of the configuration estimates to be either compatible or incompatible based on a comparison the first and second line configuration estimates.

20. The system of claim 19, further comprising:
a means to revise at least one of the first or second line configuration estimates by modifying at least one of the SELT or DELT analysis, respectively, in response to determining at least one attribute is incompatible; and
a means to repeat the comparison after revising one of the first or second line configuration estimates.
